(19) United States
(12) Patent Application Publication
(10) Pub. No.: US 2008/0309105 A1
(43) Pub. Date: Dec. 18, 2008

(54) MATERIAL PUSHING DEVICE AND METHOD FOR USE

(76) Inventor: Eric HAYNER, Johnstown, NY (US)

Correspondence Address: HESLIN ROTHENBERG FARLEY & MESITI PC, 5 COLUMBIA CIRCLE, ALBANY, NY, 12203, US

(21) Appl. No.: 11/761,755

(22) Filed: Jun. 12, 2007

(51) Int. Cl. A01B 1/02

(52) U.S. Cl. 294/49

(57) ABSTRACT

A material handling tool adapted for pushing material along a surface, for example, for pushing leaves across a lawn. The tool includes at least one elongated blade having a leading edge adapted to contact material and a bottom adapted to contact the surface and a collection surface mounted to the trailing edge of the blade which is positioned to receive the material from the deflector baffle. The tool also includes a transition between the collection surface and the trailing edge of the blade that positions the bottom of the blade substantially parallel to the surface of the lawn. The blade may be attached to a handle for manual use, or may be attached to automated machinery or to a vehicle. Though uniquely adapted for use as a lawn tool, the invention may also be used for pushing a broad range of materials, including snow, construction materials, and soil.

### TECHNICAL FIELD

Broadly, the present invention provides material handling tools and methods for using the tools. Specifically, the present invention comprises a tool for pushing material along a surface, for example, pushing leaves or yard debris along the surface of a lawn.

### BACKGROUND OF THE INVENTION

Every fall, homeowners and property owners in northern climates are presented with the task of removing fallen leaves from lawns, roadways, sidewalks, and other areas. The annual task is labor and time intensive and typically requires the use of some form of rake to draw the leaves and other yard debris into piles for subsequent bagging or other means of removal. The conventional lawn rake has typically been an adequate tool for the task, and few if any alternative devices are available. The present invention provides a novel improvement in the art of collecting lawn debris, such as leaves, as well as collecting any other material that needs to be displaced along a surface.

Various alternative devices for displacing leaves and other lawn debris have been proposed. For example, U.S. Pat. No. 5,069,026 issued to Johnson discloses a push-pull rake which has a body which includes a rake body, a platform having a top surface, a bottom surface, front and rear and opposing sides between front and rear. U.S. Pat. No. 4,970,853 issued to Greene, III discloses a push rake for leaves that has a bearing member and tines defining an arcuate bottom. U.S. Pat. No. 5,918,920 issued to Tamburro, Sr. discloses a combined rake and gathering tool for raking and scooping up leaves. U.S. Patent Application No. 2004/0112036 A1 issued to Savas discloses a device for removing pine needles imbedded in screening material by providing a rake head with outer edge portion having curved multiple fingers. U.S. Pat. No. 3,979,890 issued to Schenk discloses a rake for gathering fallen nuts that has a hopper formed by tines with curved portions having upturned tips. U.S. Design Pat. 303,912 issued to Butler discloses an ornamental design for a hand held tool for packing and loading leaves. U.S. Design Pat. 500,237 issued to Niswonger discloses an ornamental design for a rake. U.S. Patent Application No. 2004/0178646 A1 issued to Root, et al. discloses an apparatus used in collecting debris, for example, leaves, over ground or another surface area. However, none of these prior art devices provide a material pushing tool that can effectively displace material from a surface, such as a lawn, with reduced effort and reduced strain on the user.

Aspects of the present invention provide material pushing tools and methods for using the tools that are not found in the prior art. The present invention overcomes the disadvantages of the prior art while facilitating the handling of material, such as yard debris, by, for example, reducing the friction between the tool and the surface over which the material pushed.

### SUMMARY OF THE INVENTION

One aspect of the invention is a material handling tool having at least one elongated blade having a leading edge, a trailing edge, a top, and a bottom, the leading edge adapted to contact material and the bottom adapted to contact a surface; a collection surface mounted to the trailing edge of the at least one elongated blade, the collection surface positioned to receive material from the elongated blade; and a transition between the collection surface and the trailing edge of the elongated blade adapted to position the bottom of the elongated blade substantially parallel with the surface. In one aspect, the transition may include at least two bends, for example, at least 45 degree bends. The material handling tool can be adapted to handle a broad range of materials over any surface, but is unequally adapted to push leaves or other lawn debris across a lawn. In one aspect, the bottom of the elongated blade comprises a plurality of depressions, for example, radiused depressions.

Another aspect of the invention is a material pushing device including at least one elongated blade having a leading edge, a trailing edge, a top, and a bottom, the leading edge adapted to contact material and the bottom adapted to contact a surface; a collection surface mounted to the trailing edge of the at least one elongated blade, the collection surface positioned to receive material from the elongated blade; and a transition between the collection surface and the trailing edge of the elongated blade adapted to position the bottom of the elongated blade substantially parallel with the surface; and an elongated handle mounted to the pushing device. In one aspect of the invention, the transition may comprise at least two bends, for example, at least two 45-degree bends. In one aspect, the device is adapted to push material over a lawn, for example, to push fallen leaves over a lawn.

A further aspect of the invention is a method for displacing material along a surface, the method including passing a leading edge of an elongated blade across the surface whereby the leading edge contacts the material and displaces the material from the surface; passing the material from the elongated blade to a collection surface mounted to the elongated blade; and retaining at least some material on the collection surface. In one aspect, the method is practiced using the tool or device described above. In one aspect, passing the leading edge of the elongated blade across the surface comprises manually passing the leading edge of the elongated blade. In another aspect, the material being handled may comprise leaves and the surface may comprise a lawn.

These and other aspects, features, and advantages of this invention will become apparent from the following detailed description of the various aspects of the invention taken in conjunction with the accompanying drawings

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of a material-handling tool according to one aspect of the invention.

FIG. 2 is a front elevation view of the tool shown in FIG. 1.

FIG. 3 is a side elevation view of the tool shown in FIG. 1.

FIG. 4 is a rear elevation view of the tool shown in FIG. 1.

FIG. 5 is a detailed view of side elevation of the tool shown in FIG. 3 as identified by Detail 5 in FIG. 3.

FIG. 6 is a detailed view of front elevation of the tool shown in FIG. 2 as identified by Detail 6 in FIG. 2.

FIGS. 7 and 8 are detailed views similar to FIG. 5 illustrating alternative tool geometries according to aspects of the invention.

FIG. 9 is a detailed view of the bottom of the tool shown in FIG. 6 as viewed along View 9 shown in FIG. 6 according to an aspect of the invention.

### DETAILED DESCRIPTION

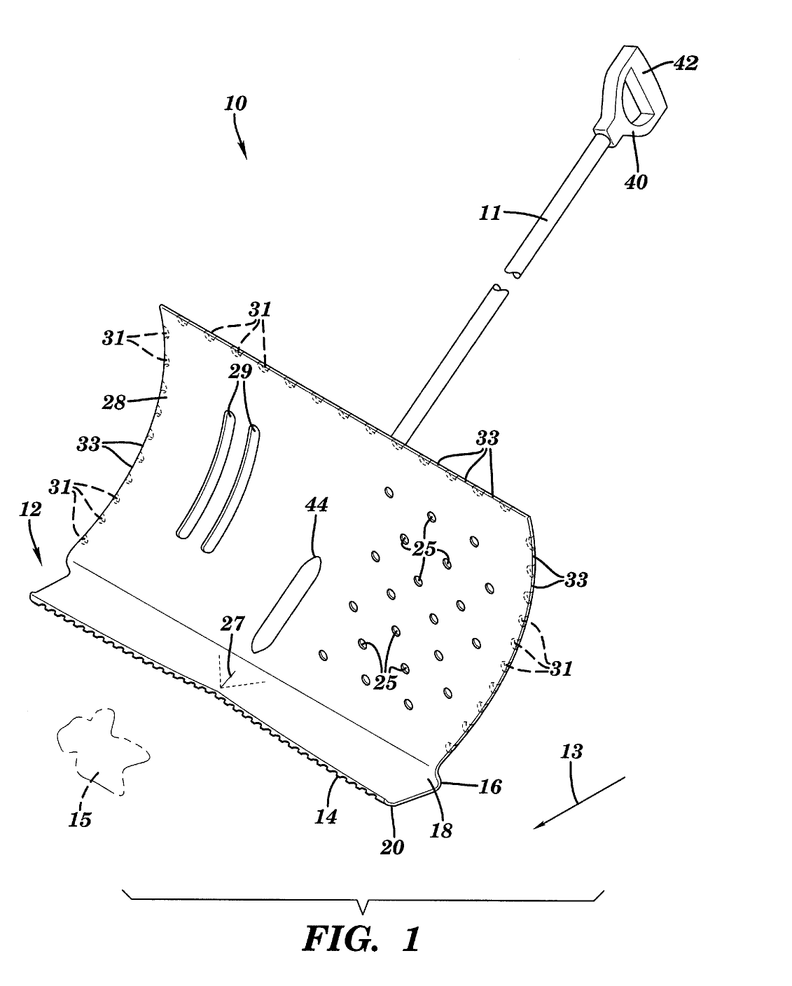

FIG. 1 is a perspective view of a material-handling tool 10 according to one aspect of the invention. Tool 10 includes at least one elongated blade 12 that may be mounted to a handle 11, or other motive means, and pushed in the general direction shown by arrow 13 to move material 15, for example, leaves, mown grass, or debris, (shown schematically in phantom in FIGS. 1 and 3). Blade 12 includes a leading edge 14, a trailing edge 16, a top 18, and a bottom 20. According to aspects of the invention, leading edge 14 is adapted to contact material 15 and bottom 20 is adapted to contact a surface 24 (see FIG. 3), for example, the surface of a lawn, a driveway, a street, a carpet, a floor, etc., among other surfaces, as material 15 is pushed along surface 24.

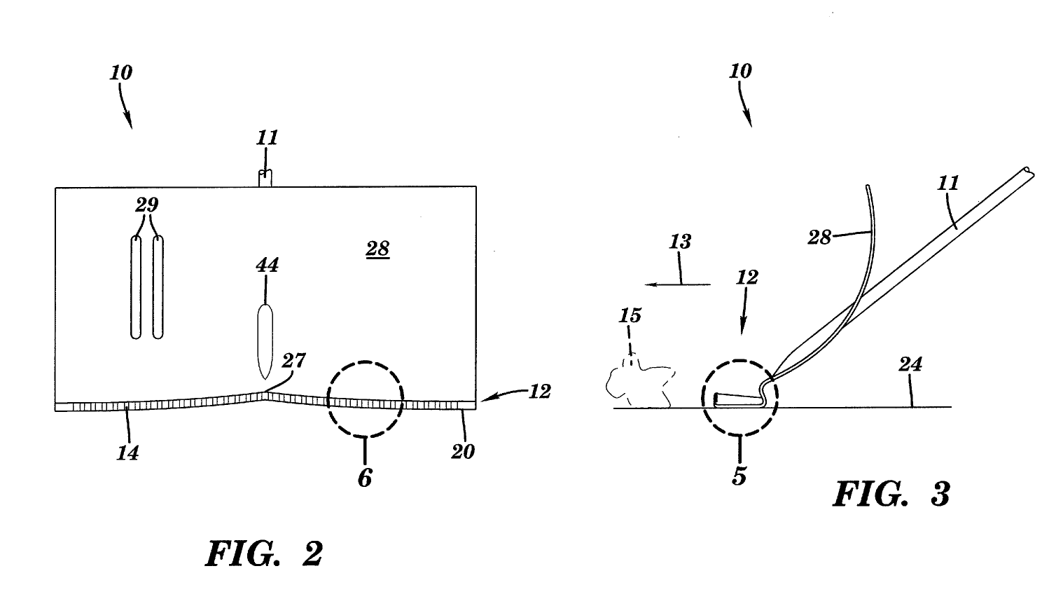

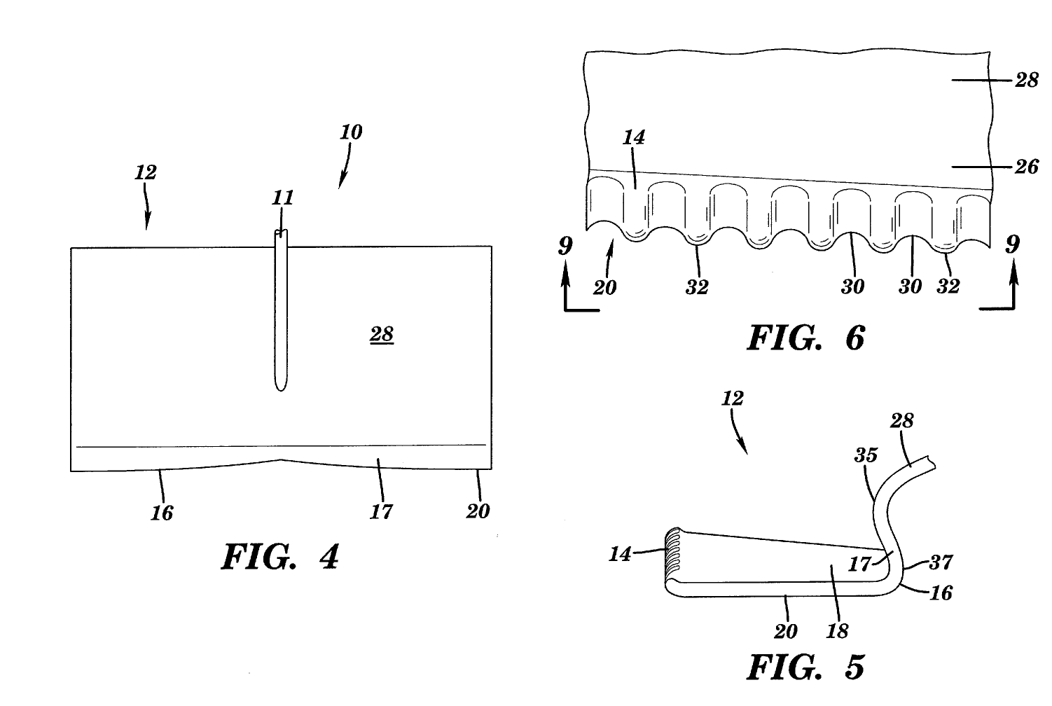

FIG. 2 is a front elevation view of the tool 10 shown in FIG. 1; FIG. 3 is a side elevation view of tool 10 shown in FIG. 1; and FIG. 4 is a rear elevation view of tool 10 shown in FIG. 1. FIG. 5 illustrates a detailed view of the side elevation of blade 12 shown in FIG. 3 and identified by Detail 5 in FIG. 3. FIG. 6 is a detailed view of front elevation of tool 10 shown in FIG. 2 as identified by Detail 6 in FIG. 2.

As shown in FIG. 1, tool 10 typically includes a collection surface 28 mounted to elongated blade 12, for example, mounted to trailing edge 16. Collection surface 28 is positioned to receive material 15, for example, as material 15 is lifted and displaced by leading edge 14 as tool 10 moves in the direction of arrow 13. Collection surface 28 provides a location for collecting material 15 as tool 10 is pushed through material 15. Typically, collection surface 28 functions as a temporary collection surface as tool 10 is manipulated to engage and transfer material 15 repeatedly. In one aspect, collection surface 28 may be used to collect material 15 for transport, for example, when tool 15 functions as a shovel to lift and transport material 15 collected on surface 28. Though collection surface 28 may be a flat planar surface, collection surface 28 may typically be concave as shown in FIGS. 1 and 3. Also, though not shown in FIG. 1 or 3, collection surface 28 may include one or more side or rear baffles adapted to retain material 15 on collection surface 28 during pushing or transport. As shown in FIGS. 1 and 2, collection surface 28 may be perforated, for example, containing a plurality of holes 25 an/or slots 29 of uniform or varying shape and dimension, for example, about ½-inch in diameter or width. Holes 25 or slots 29 may be provided to reduce the weight and/or reduce the air resistance to the movement of tool 10.

As shown most clearly in FIG. 1, collection surface 28 may include at least one row of indentations, depressions, or serrations 31 (shown in phantom) along one or more edges of collection surface 28. Serrations 31 may define projections or “teeth” 33 there between that are adapted to be passed over a surface, such as, surface 24, and provide a raking function, for example, to augment the function of blade 12. According to an aspect of the invention, serrations 31 and teeth 33 allow tool 10 to be used as a “back blade” or “raking” tool in addition to the pushing tool. For example, serrated edges of tool 10 may be used to remove material when there is insufficient room or where it is undesirable to push the material, for instance, along a tree line, along a rock wall, along a fence line, or along a building or structure, among other areas. The serrations 31 may have axes that are substantially perpendicular to the surface of collection surface 28, but the serration axes may also make an oblique angle. For example, the axes of serrations 31 may make an angle of at least 15 degrees with a perpendicular line drawn from the surface of surface 28, for example, at least 30 degrees. That is, serrations 31 may be “back angled” to enhance the raking function of serrations 31. In one aspect, serrations 31 may be from about 0.125 to about 2 inches deep, but are typically about 0.25 to about 0.5 inches deep, for example, about 0.38 inches deep. Teeth 33 may be about 0.125 to about 2 inches wide, but are typically about 0.13 to about 0.38 inches deep, for example, about 0.25 inches wide.

In one aspect, collection surface 28 may be mounted to blade 12 whereby material 15 lifted by blade 12 from surface 24 is transferred to collection surface 28. In one aspect, collection surface 28 may be mounted directly to blade 12. In another aspect, collection surface 28 may be mounted to intermediate plate or transition 17 (see FIG. 5) positioned between blade 12 and collection surface 28, for example, to provide a transition between the geometry and/or position of blade 12 and the geometry and or position of collection surface 28. Transition 17 between may be adapted, for example, radiused, bent, or otherwise formed, to position the bottom 20 of the elongated blade 12 substantially parallel with the surface over which material is being pushed, for example, surface 24. According to one aspect of the invention, the substantially parallel positioning of blade 12 with respect to surface 24 reduces or minimizes friction between blade 12 and surface 24 to facilitate use of tool 10. In one aspect, friction between blade 12 and surface 24 may be further reduced or minimized by employing depressions 30 (discussed below).

As shown in FIG. 5, transition 17 may include at least two bends 35 and 37, for example, at least two bends each comprising at least about 45 degree bends, and may be about 90-degree bends. Transition 17 may also provide at least some structural rigidity to tool 10. The function of transition 17 may be incorporated into trailing edge 16 of blade 12, whereby trailing edge 16 is shaped, for example, radiused, bent, or otherwise formed, to provide a transition between blade 12 and collection surface 28. In one aspect, the height of transition 17 or trailing edge 16 is provided whereby the contour of blade 12 is adapted to promote movement of material to the surface of collection surface 28. For example, in one aspect, the blade 12 may have a curvature or be radiused in the plane substantially perpendicular to the direction of elongation of blade 12. The curvature of blade 12 may conform to the position of collection surface 28 whereby material passing over blade 12 passes with little or no restriction to collection surface 28.

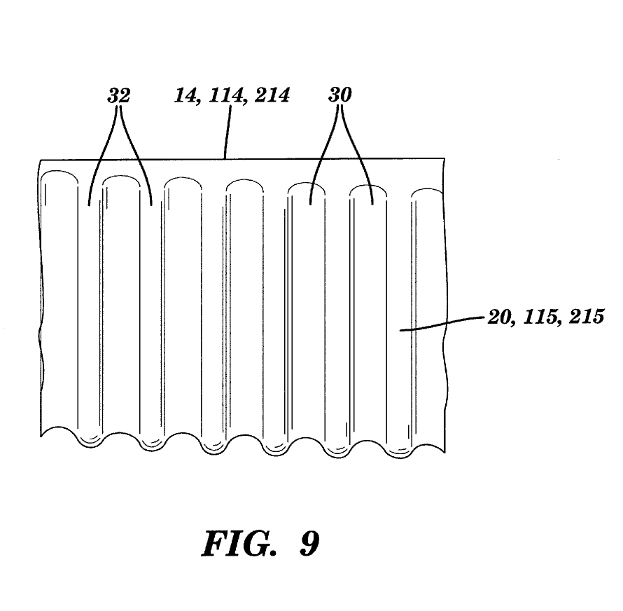

The shape of bottom 20 of blade 12 may vary depending upon the material 15 being pushed or the surface 24 contacted by bottom 20. Bottom 20 may be positioned to be substantially parallel to surface 24 whereby bottom 20 may “float” or “plane” along surface 24. Bottom 20 may be substantially flat or radiused as shown in FIG. 5, for example, radiused in a plane substantially perpendicular to the direction of elongation of blade 12. As shown most clearly in FIG. 6, in one aspect, bottom 20 of blade 12 may be corrugated and include a plurality of depressions 30, for example, elongated radiused depressions, which may alternate with ridges 32, for example, radiused ridges. According to one aspect of the invention, depressions 30 and ridges 32 provide at least some relief to the friction between blade 12 and surface 24 so that tool 10 can more easily translate along surface 24. In one aspect, depressions 30 and ridges 32 provide at least some variation or reduction in the contact area between bottom 20 of blade 12 and surface 24 whereby friction between bottom 20 and surface 24 is reduced. Depressions 30 and ridges 32 may not be radiused, for example, depressions 30 and/or ridges 32 may be provided with relatively sharp internal and external corners, respectively. However, in one aspect, smooth, radiused, elongated depressions 30 and ridges 32 are more amenable to manufacture, styling, and handling. In one aspect, the alternating depressions 30 and ridges 32 may provided a “combing” effect upon the surface, for example, to displace leaves and sticks embedded in a lawn. Further details on the surface of bottom 20 are illustrated and discussed with respect to FIG. 9 below.

As shown most clearly in the detail of FIG. 5, leading edge 14 of blade 12 may be a radiused leading edged. However, in one aspect, leading edge 14 may have a sharp point. The shape of leading edge 14 may vary depending upon the use of tool 10. For example, to push easily movable material 15, such as, leaves or debris, a more rounded or radiused edge may be desired. However, when pushing more resistant material, such as ice or snow from a frozen surface, such as a rink, a sharper leading edge may be desired.

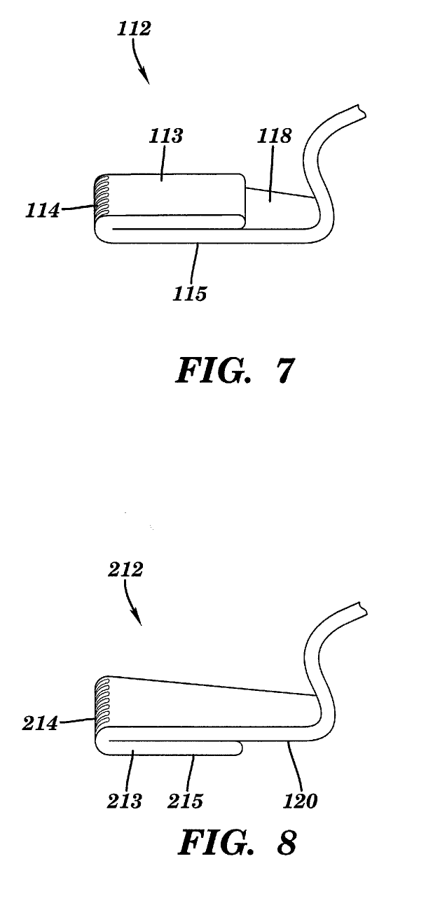

In one aspect of the invention, tool blade 12 may be made from a hard or durable material that can withstand constant abrasion against material 15 and surface 24. For example, blade 12 may be made from a metallic material, for example, aluminum or steel, or a hard non-metallic material, such as a high-molecular weight polymer or Kevlar. In one aspect of the invention, blade 12 may be reinforced with a durable material; for example, blade 12 may include a harder cover or sheath mounted over a softer material. In one aspect, blade 12 may include a metallic cover or sheath, for example, a cover molded into or riveted to blade 12, for example, over the leading edge 14 of blade 12. FIGS. 7 and 8 are detailed views similar to FIG. 5 illustrating alternative tool geometries according to aspects of the invention.

FIG. 7 illustrates a tool blade 112 having an alternate shape to tool blade 12 shown in FIG. 5. In the aspect of the invention shown in FIG. 7, blade 112 is fabricated by providing a fold 113 over the top 118 of blade 112. The folding of fold 113 may provide a rounded leading edge 114. Fold 113 may typically made from the same material from which the remainder of blade 112 is made, for example, one or more of the plastics mentioned below. Fold 113 may be attached to top 118 of blade 112 by means of mechanical fasteners or an adhesive. By providing fold 113 to blade 112, a stronger, more durable, and more rigid structure may be provided, for example, a blade 112 less prone to damage or breakage. In a similar manner, FIG. 8 illustrates another tool blade 212 having an alternate shape to tool blade 112 shown in FIG. 7. In this aspect, blade 212 includes a fold 213 about a bottom 120 of blade 212. The folding of fold 213 may provide a rounded leading edge 214. Fold 213 may have all the features and functions of fold 113 described above. Consistent with other aspects of the invention, the bottom surface 115 of fold 113 and the bottom surface 215 of fold 213 may be provided with elongated depressions, for example, depressions similar to depressions 30 described above, to reduce friction with the surface.

FIG. 9 is a detailed view of the bottom surface 20 of the tool shown in FIG. 6 as viewed along View 9 shown in FIG. 6 according to an aspect of the invention. Surface 20 may also be similar to surfaces 115 and 215 shown in FIGS. 7 and 8. As shown in FIG. 9, surfaces 20, 115, and 215 may include a plurality of alternating elongated depressions 30 and ridges 32, for example, radiused depressions and ridges, to provide reduced friction between surfaces 20, 115, 215 and the surface over which tool 10 is pushed. As also shown in FIG. 9, depressions 30 may also be radiused at their ends adjacent to leading edge 14, 114, or 214.

As shown in FIG. 1, tool 10 may include one or more an elongated handles 11, for example, an elongated wooden handle 11 having one or more handgrips 40, whereby the invention provides a pushable rake. Handle 11 may be mounted to tool 10 whereby the user to remain upright with little or no need to bend while using tool 10. In one aspect, handle 20 may be relatively long whereby the use may remain substantially in an upright position and require little or no bending. Handle 11 may also have an S-type shape or offset shape to facilitate use by the user. Handle 11 may be mounted to tool 10 by conventional means, for example, by means of mechanical fasteners or welding. As shown in FIGS. 1 and 2, handle 11 may penetrate collection surface 28 whereby one or more penetrations 44 are provided in collection surface 28. In other aspects of the invention, handle 11 does not penetrate collection surface 28. Handle 11 may contact transition 17 whereby the force applied to handle 11 is directed as close to blade 12 as possible, for example, as close to leading edge 14 as possible, to apply the most force where needed to contact and displace material 15. Handgrip 40 may be oriented at any orientation to facilitate use of tool 10. As shown in FIG. 1, handgrip 40 may have a gripping bar 42 oriented at an angle substantially perpendicular to the axis defined by the direction of elongation of blade 12.

Handgrip 40 may be moveable, adjustable, or removable, for example, to adjust tool 10 to the comfort of the individual user. By adjusting handle 40, the user may provide a more efficient use of their downward force upon blade 12 and facilitate movement of tool 12, for example, in an arc-like sweeping motion along the surface.

Though tool 10 is illustrated in FIG. 1 having a handle 11, and may typically be used as a hand tool by a human user, it will be understood by those in the art that tool 10 may be adapted to mount on any device that can translate tool 10 whereby material 15 is pushed. For example, tool 10 or blade 12 may be mounted to a snow shovel, a plow, or a vehicle and function as a plow for snow, ice, debris, dirt, stone, sand, gravel, asphalt, refuse (such as landfill refuse), soil (such as in agricultural use), and the like. Tool 10 may also be mounted to a material handling device to distribute, spread, or coat a flowable material over a surface, for example, an adhesive, a pharmaceutical, a cake frosting, and the like. Other applications of aspects of the invention will be apparent to those of skill in the art.

As discussed above with respect to blade 12, tool 10 may be fabricated by any conventional means. For example, blade 12, baffle 26, and collection surface 28 may be fabricated from component parts by mechanical fasteners, welding, adhesives, and the like. Blade 12, transition 17, and collection surface 28 may also be fashioned as one or more integral components, for example, molded from a single piece of moldable material, extruded as an integral extrusion, or otherwise fashioned from a single sheet or plate of material, such as a plastic, for instance, a polyamide (PA), for example, nylon; a polyamide-imide; a polyethylene (PE); a polypropylene (PP); a polyester (PE); a polytetrafluoroethylene (PTFE); an acrylonitrile butadiene styrene (ABS); a polycarbonate (PC); or a vinyl, such as, polyvinylchloride (PVC), among other plastics, or a metal, for instance, aluminum or steel. Other means of manufacture will be apparent to those of skill in the art.

Though tool 10 may vary in size and shape depending upon the application. In one aspect, tool 10, that is, tool blade 12 and collection surface 28, is about 20 to 24 inches wide. The width of tool 10 may also vary. For example, blade 12 may be wider or narrower than collection surface 28. In one aspect, leading edge 14 may vary about 22 inches in width, the width of collection surface 28 may increase from about 22 inches to about 27 inches at the top edge of collection surface 28. The tapering of tool 10 may facilitate the use of serrations 31 when raking or “back blading.”

Aspects of the present invention provide a tool and a method of using the tool that are absent in the existing art. According to the invention, a tool is provided that facilitates the displacement, distribution, and/or collection of a broad range of materials. Aspects of the invention are uniquely adapted to handle yard waste, for example, leaves and grass, but, as discussed above, a broad range of materials may be handled by aspects of the invention.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A material pushing tool comprising:
at least one elongated blade having a leading edge, a trailing edge, a top, and a substantially planar bottom between the leading edge and the trailing edge, the leading edge adapted to contact material and the substantially planar bottom adapted to contact a surface along which the material is pushed;
a collection surface mounted to the trailing edge of the at least one elongated blade, the collection surface positioned to receive material from the elongated blade; and
an S-shaped transition between the collection surface and the trailing edge of the elongated blade adapted to position the substantially planar bottom of the elongated blade substantially parallel with the surface along which the material is pushed.

2. The tool as recited in claim 1, wherein the S-shaped transition comprises at least two bends.

3. The tool as recited in claim 2, wherein the at least two bends comprise at least 45 degree bends.

4. The tool as recited in claim 1, wherein the substantially planar bottom of the elongated blade comprises a plurality of depressions.

5. The tool as recited in claim 4, wherein the depressions comprise elongated depressions.

6. The tool as recited in claim 4, wherein the depressions comprise radiused depressions.

7. The tool as recited in claim 1, wherein the leading edge of the elongated blade comprises a radiused leading edged.

8. (canceled)

9. The tool as recited in claim 1, wherein the collection surface comprises at least one side baffle adapted retain material on the collection surface.

10. The tool as recited in claim 1, wherein the collection surface is perforated.

11. (canceled)

12. The tool as recited in claim 1, wherein the tool further comprises an elongated handle.

13. A material pushing device comprising:
at least one elongated blade having a leading edge, a trailing edge, a top, and a substantially planar bottom between the leading edge and the trailing edge, the leading edge adapted to contact material and the substantially planar bottom adapted to contact a surface along which the material is pushed;
a collection surface mounted to the trailing edge of the at least one elongated blade, the collection surface positioned to receive material from the elongated blade; and
an S-shaped transition between the collection surface and the trailing edge of the elongated blade adapted to position the substantially planar bottom of the elongated blade substantially parallel with the surface along which the material is pushed; and
an elongated handle mounted to the pushing device.

14. The device as recited in claim 13, wherein the S-shaped transition comprises at least two bends.

15. The device as recited in claim 14, wherein the at least two bends comprise at least 45 degree bends.

16. The device as recited in claim 13, wherein the substantially planar bottom of the elongated blade comprises a plurality of depressions.

17. The device as recited in claim 16, wherein the depressions comprise elongated depressions.

18. The device as recited in claim 16, wherein the depressions comprise radiused depressions.

19. The device as recited in claim 13, wherein the device is adapted to push material over a lawn.

20. The device as recited in claim 19, wherein the tool comprises a leaf-pushing device.

21. The device as recited in claim 1, wherein the collection surface comprises a radiused collection surface.

22. The device as recited in claim 13, wherein the collection surface comprises a radiused collection surface.
